(19) United States
(12) Patent Application Publication
(10) Pub. No.: US 2015/0193722 A1
(43) Pub. Date: Jul. 9, 2015

(54) APPARATUS AND METHOD FOR ATTRIBUTE-BASED SCHEDULING

(71) Applicants: Conrad Delbert Seaman, Guelph (CA); David Rene Proulx, Waterloo (CA); Sathwant Dosanjh, Toronto (CA)

(72) Inventors: Conrad Delbert Seaman, Guelph (CA); David Rene Proulx, Waterloo (CA); Sathwant Dosanjh, Toronto (CA)

(73) Assignee: BLACKBERRY LIMITED, Waterloo, ON (CA)

(21) Appl. No.: 14/418,238

(22) PCT Filed: Jul. 31, 2012
(86) PCT No.: PCT/CA2012/050521

§ 371 Date: Jan. 29, 2015

(51) Int. Cl. G06Q 10/06; G06Q 10/10

(52) U.S. Cl. CPC G06Q 10/063114; G06Q 10/1095

(57) ABSTRACT

An apparatus and method are provided, the method includes retrieving tasks from a memory, each task associated with a non-temporal attribute; and displaying the tasks in a group or list relative to the non-temporal attribute.

### TECHNICAL FIELD

The following relates to attribute-based scheduling.

### DESCRIPTION OF THE RELATED ART

Electronic devices may be used to schedule tasks in a calendar-type application. For example, electronic devices enable users to input the time, date, and location of an upcoming calendar event such as a meeting, appointment, task or engagement; and may prompt a user with a reminder prior to the event.

Some electronic devices may enable users to share calendar appointments or invite and accept invitations from other users to particular events or meetings. For example, a user of a first electronic device may invite a user of a second electronic device to a meeting. The first electronic device typically provides the second electronic device with an invitation and the option to accept or decline the meeting.

Calendar applications on electronic devices may enable users to modify calendar appointments and tasks, add information to a calendar appointment or task, and delete calendar appointments. For example, a user of a calendar application on an electronic device may be able to move a calendar appointment from a particular day of the week and/or a particular hour of the day to a different day of the week and/or a different hour of the day.

### BRIEF DESCRIPTION OF THE DRAWINGS

Embodiments will now be described by way of example only with reference to the appended drawings wherein:

FIG. 1 is a block diagram of an example apparatus for attribute-based scheduling;

FIG. 2 is a flow diagram of example operations for creating an attribute-based task;

FIG. 3 is a flow diagram of example operations of a scheduling module that is configured to generate a calendar display of tasks;

FIG. 4 is flow diagram of example operations of a rescheduling module that is configured to reschedule all tasks related to a particular attribute to a new time period;

FIG. 5 is an example attribute-based scheduling user interface that shows a grid of attribute-based tasks;

FIG. 6 is an example attribute-based scheduling user interface that shows an attribute-based task list and an attribute-based schedule;

FIG. 7 is an example attribute-based scheduling user interface that shows the tasks of FIG. 6 rescheduled for the following day;

FIG. 8 is a weekly view of an example attribute-based scheduling user interface;

FIG. 9 is a weekly view of an example attribute-based scheduling user interface that shows a Monday schedule based on attribute; and

FIG. 10 is a weekly view of an example attribute-based scheduling user interface that shows each daily schedule based on attribute;

FIG. 11 is a weekly view of an example attribute-based scheduling user interface that shows tasks associated with a particular attribute rescheduled to the next day; and

FIG. 12 is a block diagram illustrating an example of a configuration of an electronic device.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments described herein may be practiced otherwise. That is, the description is not to be considered as limiting the scope of the embodiments described herein. To this end it will be appreciated that the examples and corresponding diagrams used herein are for illustrative purposes only. Different configurations and terminology can be used without departing from the principles expressed herein. For example, components and modules can be added, deleted, modified, or arranged with differing connections without departing from these principles.

It will also be appreciated that that any module, component, server, computer, terminal or device exemplified herein that executes instructions may include or otherwise have access to computer readable media such as volatile and non-volatile, removable and non-removable tangible or non-transitory media implemented in any method or technology for storage of information, such as computer readable instructions, data structures, program modules, or other data. Examples include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

For existing calendar applications such as those described above, calendar tasks and appointments are typically treated as unrelated events. For example, in the case of a physician visiting patients in different wards of a hospital on a particular day, the physician may have 3 appointments in ward A, 2 appointments in ward C, and 6 appointments in ward E. Although ward or location information may be provided in the calendar appointment, no connection or association is made between the appointments with patients in each of the wards. If a particular ward, for example, ward E, were to be isolated or inaccessible, the physician would have to manually and individually reschedule each of the appointments to an available time period on another day.

It has been recognized that by associating tasks and appointments with a particular attribute, manipulation and rescheduling of tasks linked to a particular attribute may be facilitated. It has also been recognized that by associating tasks and appointments with a particular attribute, the tasks and appointments may be presented or displayed in an organized arrangement to a user of an electronic device. In example embodiments, an attribute may be non-temporal such that it specifies or defines a person, an organization, a location (e.g. a country, state, province, campus), a particular venue at a location, a set of geographic coordinates, or any other element that may be common amongst tasks. It will be appreciated that a task or appointment may be linked to one or more non-temporal attributes, for example, a person and a location or multiple locations.

As used herein the term “appointment” may be any engagement or calendar event having a specific date and time, for example, an appointment with a patient at 2 pm in ward E. The use of the term “task” herein refers to any engagement regardless of whether a specific date and time have been defined. A task may have a preferred date and time or a preferred range of dates and times on which the task may be performed or a deadline date and/or time by which the task should be completed.

In some example embodiments, the task may include a ranking to indicate the relative task importance, moveability (or in other words, ability to be rescheduled), or other characteristics of a task. For example, a task may be labeled as a “moveable” (able to be rescheduled) task, a “prefer not to move” (prefer not to reschedule) task, or a “cannot move” (cannot reschedule) task. In circumstances where it would be convenient to reschedule a task, for example, when the user is delayed in commencing a list of tasks, the “moveable” tasks would be first to be rescheduled, followed by the “prefer not to move” tasks. However, although the foregoing example describes three possible categories of moveability, any other number of categories may be used.

In some embodiments, the task may include a task importance ranking. For example, a task may be labeled as “low priority”, “important” or “critical”. In circumstances where a user may not be able to complete one of several tasks on a particular day, the “low priority” task may be rescheduled or canceled before an “important” or “critical” task is affected. Similarly, an “important” task may be rescheduled or canceled prior to a “critical” task being affected.

A task may also be ranked by its temporal importance with respect to other tasks. A task may be unmovable in date, location, or time. Tasks may also be assigned rankings to indicate their relative or absolute importance. “Movable” and “prefer not to move” tasks may be moved to alternate dates, locations, and times. “Moveable ” and “prefer not to move” tasks may be provided with a date range in which the task may be moved. An example “moveable” or “prefer not to move” task may include delivering medication to a patient in ward E anytime on Wednesday. As defined herein, the term task may relate to an appointment. Attributes associated with a task may be modified or changed. For example, a task associated with a non-temporal attribute, for example, ward A, may be dissociated with ward A and associated with ward E.

Each ranking may be given a representative value such as an integer numeral, in the example of the task importance ranking, the numerals may be 1 for “critical”, 2 for “important”, and 3 for “low priority”. Similar numerals may be assigned for the moveability ranking and the temporal importance ranking. In some example embodiments, the temporal importance may be used with the task importance ranking to determine whether to reschedule or cancel an engagement. For example, a global importance ranking may be obtained by performing an operation of the numerals representing any ranking criteria. For example, the task importance ranking may be multiplied or added with the temporal importance ranking to obtain a global importance ranking. In the example of a multiplication, the task or appointment with the highest rank would be the most globally important and would therefore be the last task to be rescheduled or canceled.

In one example aspect, an apparatus is provided for associating tasks with an attribute. The apparatus may enable a user to input a task in an electronic device and associate that task with a particular attribute or with a plurality of attributes. The apparatus may enable a user to manage a group of tasks based on a common attribute with which the tasks are associated.

In another example aspect, a method of associating tasks with an attribute is provided. The method includes enabling a user to associate a task with an attribute. The method may further include enabling a user to enter a task prior to associating the task with an attribute.

In yet another example aspect, a user interface for viewing tasks linked to attributes is provided. The user interface may include a plurality of task lists, each list being linked to an attribute.

In yet another example aspect, a user interface for viewing appointments linked to attributes is provided. The user interface may include a plurality of appointments, each appointment being linked to a particular attribute. For example, the user interface may present or provide a calendar showing several appointments, each appointment being visually linked to a particular attribute.

Although examples are given with reference to a user scheduling an appointment, known scheduling techniques may be combined with those described herein. For example, a user may invite another user to assist in completing a task that is tied to an attribute.

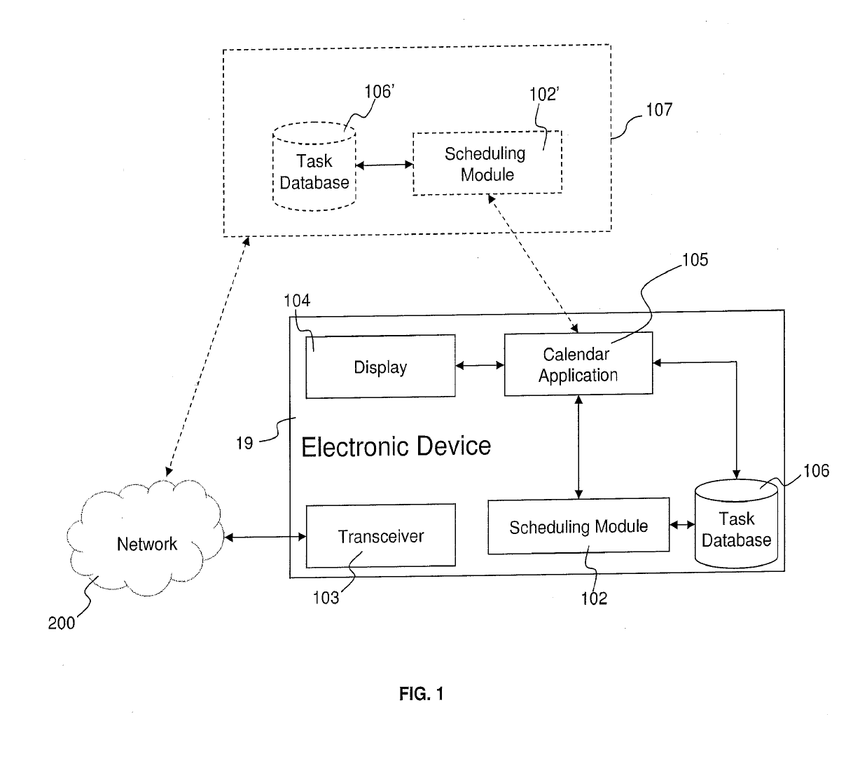

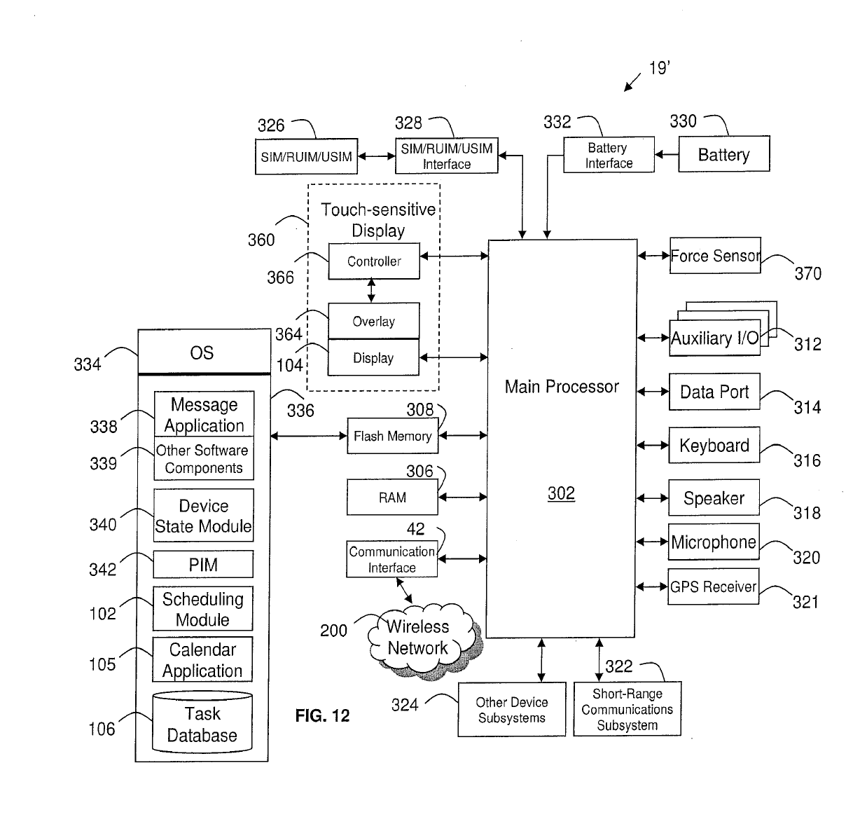

Turning now to the example embodiment of FIG. 1, an electronic device 19 includes a display 104 and a transceiver 103. The electronic device 19 includes, or is in communication with, a scheduling module 102 and a task database 106. The electronic device further includes a calendar application 105. The scheduling module 102 is in communication with the task database 106. The transceiver 103 is operable to communicate over a network 200. The scheduling module and task database may be located locally in memory on the electronic device (e.g. RAM 306, flash memory 308, etc. as shown in FIG. 12) or located remotely from the device (e.g. at a network server 107 accessible by the device over network 200 as illustrated in dashed lines and as indicated by 102′ and 106′ respectively). The calendar application 105 may be located locally (e.g. in a memory on the electronic device 19) or located remotely (e.g. hosted via a server 107 over the network 200).

The electronic device 19 may be a two-way communication device with advanced data communication capabilities including the capability to communicate with other electronic devices 19 or computer systems through a network 200 of transceiver stations or through a direct connection such as a short range wireless connection. The connection may also be established as a peer to peer connection on a mesh network. The electronic device 19 may have the capability to allow voice communications. Depending on the functionality provided by the electronic device 19, the electronic device 19 may be referred to as a data messaging device, a two-way pager, a cellular telephone with data messaging capabilities, a wireless Internet appliance, or a data communication device (with or without telephony capabilities).

It will be appreciated that although examples are provided in the context of an electronic device 19, the principles discussed herein are equally applicable to other communication devices, for example, mobile devices, cell phones, smartphones, desktop computers, laptops, tablet computers, communication systems in vehicles, electronic kiosks, etc.

It will also be appreciated that although the example of FIG. 1 is provided in the context of an electronic device 19 that includes a scheduling module 102 and a task database 106, these components of the system may be hosted over the network 200 on a server. For example, the server may be a cloud server and the electronic device 19 may include a display 104 and be used as a terminal to receive and display information from the cloud server. In this example embodiment, the electronic device 19 may further include one or more mechanisms for inputting information, for example, a touch screen, a microphone, a keyboard, a keypad, a mouse, etc.

The calendar application 105 is a software agent executed by a processor (e.g., processor 302 shown in FIG. 12). The calendar application 105 operable to obtain tasks from the task database 106 or from the scheduling module 102 and cause generation of a user interface which is presented to a user, for example, via the display 104. The calendar application 105 is operable to provide the scheduling module 102 and/or task database 106 with updated task information. For example, if a task is rescheduled (e.g. by a user of the device 19) using the calendar module, the calendar module 105 may provide the task database 106 with updated task information.

The scheduling module 102 is operable to obtain tasks and appointments from a user input device (e.g. touchscreen 360, keyboard 316, etc. shown in FIG. 12) and store the tasks and appointments in the task database 106. The scheduling module 102 is also operable to obtain tasks stored in the database 106 and display the tasks to the user via the display 104 on the electronic device 19. The scheduling module 102 may further be operable to reschedule tasks previously stored in the database 106.

The scheduling module 102 schedules tasks according to various pre-defined criteria. For example, the scheduling module 102 may schedule tasks to reduce idle time between tasks, to reduce travel time between attributes, to maximize revenue based on expected earnings from each task, or in order of the task importance based on a task importance ranking. “Movable” or “prefer not to move” tasks may be scheduled such that unmovable tasks are completed in an optimal order. In an example where a physician is required to complete 3 time-agnostic tasks (i.e. a task not bound to at least one of a specific start time/date and end time/date) in ward A, 2 time-agnostic tasks in ward C, and 6 time-agnostic tasks in ward E, the scheduling module 102 may obtain the time periods when each of the wards is open and schedule appointments based on the time-agnostic tasks in each of the wards. The time periods may be obtained from the user or may be obtained from a database, for example, an online calendar. The scheduling module 102 is operable to schedule the appointments to minimize the physicians travel time between wards. For example, if each of the tasks required in ward E takes 30 minutes and ward E is only open for 90 minutes in the morning and another 90 minutes in the afternoon, the physician may leave ward E to perform tasks in ward A and ward C while ward E is closed. Upon ward E opening in the afternoon, the physician may then return to ward E.

The scheduling module 102 obtains information relating to an attribute. By way of example, the scheduling module 102 may obtain the information relating to an attribute from a database or from an online source, such as the location of each of the attributes using online mapping software. In the example of a physician visiting various wards, the scheduling module 102 may obtain the location information from a database hosted by the hospital. The scheduling module 102 may then schedule appointments to reduce travel time therebetween.

Each task may be associated with a wait time corresponding to the wait time expected by the user. The wait time may be in addition to the scheduled task duration. The wait time may be obtained from the user or from a database, for example, an online database. The scheduling module 102 may be aware of the location of each attributes, for example, by a user manually inputting a location, or by the electronic device downloading a map or set of coordinates, or via global positioning system (GPS) coordinates that a user may input when at the location.

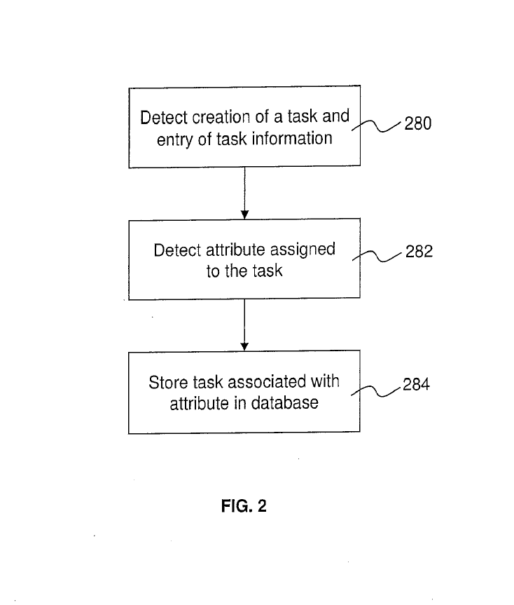

Referring now to FIG. 2, an example flow diagram for managing a task on the electronic device is provided. A user creates a task by employing an input device, for example, and provides the scheduling module 102 with task information. At 280, the scheduling module 102 detects the creation or data entry of the task information. The task may be created, for example, by a user interacting with the calendar application 105 via an input device. By way of example, a user of the calendar application 105 may input task information and the calendar application 105 may provide the task information to the task database 106. The scheduling module 102 may also provide task information to the task database 106, for example, if the scheduling module 102 reschedules a particular task.

The task information may include, for example, a title for the task, the location of the task, a description of the task, a priority for the task, a due date of the task, the date and time of the task, whether the task is movable, the eligible period within which any movable task may be rescheduled, a completion date or range of completion dates, and any other participants in the task. The task information may further include information associated with performing the task, for example, the availability of the location where the task is to be performed, directions to the location where the task is to be performed, road traffic on the way to the task, etc. The traffic information may be obtained over a network connection or using a local component such as a GPS device.

The user may have assigned an attribute to the task. At 282, the scheduling module 102 detects whether an attribute has been assigned to the task. The user may have assigned several attributes to a single task, in which case, the scheduling module 102 will detect that each of the attributes have been assigned. As described previously, the non-temporal attribute may include, specify or define a person, an organization, a location (e.g. a country, state, province, campus, building, section of a building), a particular venue at a location, a set of geographic coordinates, or any other element that may be common amongst tasks. The venue may include, for example, a building, a room, a particular office, a workstation, a piece of equipment, a website, a phone number, a set of coordinates, a body of water, a landmark, etc. At 284, the scheduling module 102 stores the task and any information associated with the task in the database 106. The database 106 may be in communication with a web server, for example, over the network 200 to obtain venue availability information. For example, the venue availability information may include the hours that the venue is open.

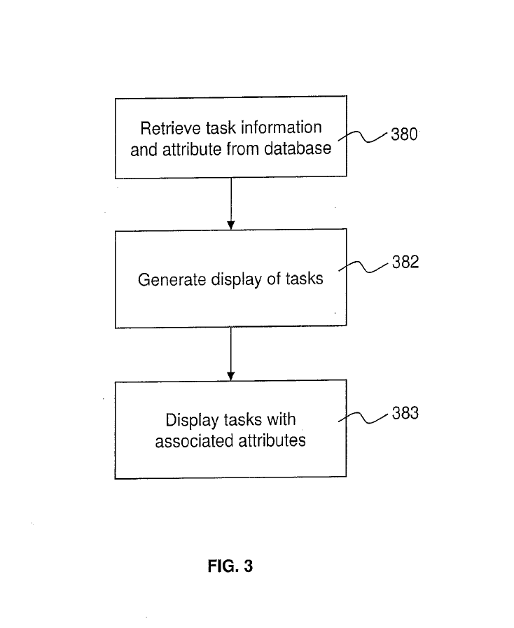

The task may also be retrieved from the database 106 by the scheduling module 102. Referring now to FIG. 3, the scheduling module 102 retrieves the task linked to an attribute from the database 106 at 380. If several tasks have been linked to the same attribute, the scheduling module 102 retrieves each of the tasks linked to the attribute. At 382, the scheduling module 102 generates a user interface to display each of the one or more tasks linked to a particular attribute, which may be displayed in cooperation with the calendar application 105. At 383, the electronic device 19 displays the user interface to a user operating the calendar application 105 using the display 104.

In some instances a user may reschedule tasks or change information linked to particular tasks. Furthermore a user may change information associated with all tasks that are linked to a particular attribute. For example, if a physician has arranged the six appointments in ward E for a Monday but the physician is unable to visit ward E, the physician may wish to move all tasks associated with ward E to the following Tuesday. The physician may otherwise transfer all tasks associated with a particular attribute to another physician. Any other participants in the task may be notified of any scheduling or attribute changes associated with the task. The scheduling module 102 is capable of rescheduling each task linked to the attribute including ward E to the following Tuesday. The scheduling module 102 may further be operable to schedule the six tasks in ward E into vacant time periods in Tuesday's schedule, as is described further below.

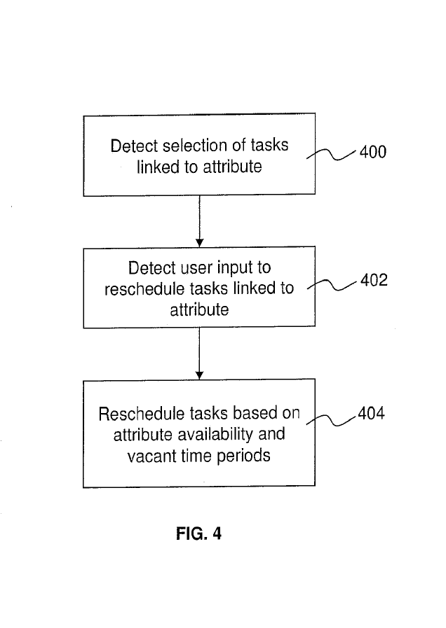

Turning now to FIG. 4, at 400, the calendar application 105 is operable (via user input) to select a list of tasks linked to a particular attribute. At 402, the user elects to reschedule all tasks linked to the attribute using an element of the user interface. The element may include a drag and drop action, a drop down menu, a single-click button, or any other known user interface element. At 404, the scheduling module 102 reschedules the tasks based on the availability of the attribute on the rescheduled day and the times of the day that the user is available. For example, the scheduling module 102 may communicate with a scheduling module of another device over a network to determine when the other user is available. The scheduling module 102 may obtain user availability and attribute availability through an existing database or existing scheduling tool, for example, MS Outlook. Upon the tasks being scheduled, the scheduling module 102 may confirm with the user of the calendar application 105 that the rescheduled task times are acceptable.

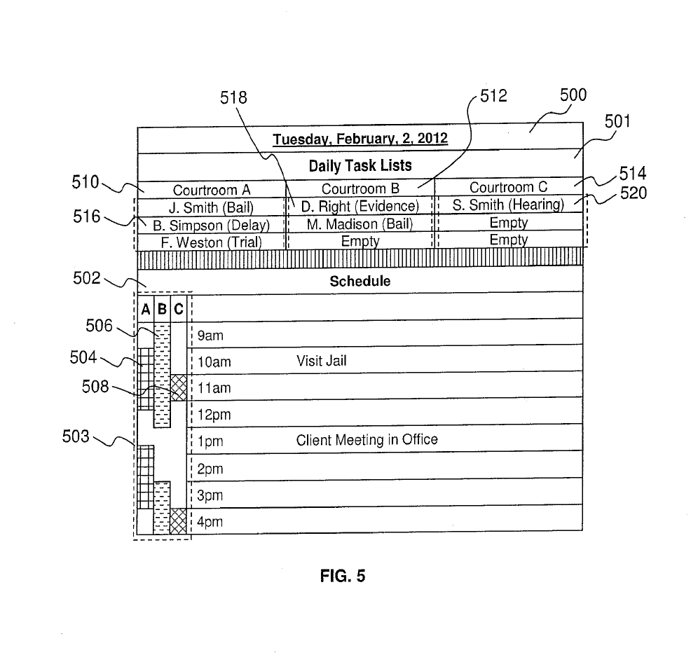

Referring to FIG. 5, an example user interface for displaying a list of tasks sorted by attribute as well as a schedule showing the availability of each of the attributes is provided. The user interface in this example is provided by the calendar application 105. The user interface includes a title 500 indicating the time period that the task lists and schedule represent. The user interface may be divided into a first portion showing a daily task list 501 of all tasks that are to be completed on a particular day. The tasks may be sorted by the attribute to which they are linked. In the example of a user who is a lawyer, as is shown in FIG. 5, the attributes correspond to three separate courtrooms at a courthouse. In courtroom A 510 which is a first attribute, the user has three tasks 516 to complete, in courtroom B 512 which is a second attribute, the user has two tasks 518 to complete and in courtroom C 514 which is a third attribute the user has only a single task to complete 520.

Each of these tasks may be manually dragged by a user into an available slot in the schedule 502. Alternatively, the scheduling module 102 may schedule each of the tasks in an optimal schedule, as was described above. A summary (e.g. chart or other visual representation of tasks organized or grouped by attribute) 503 may display the periods in the day when each of the attributes is available and busy/unavailable. For example, bar 504 represents the availability of Courtroom A, 506 represents the availability of Courtroom B and 508 represents the availability of Courtroom C.

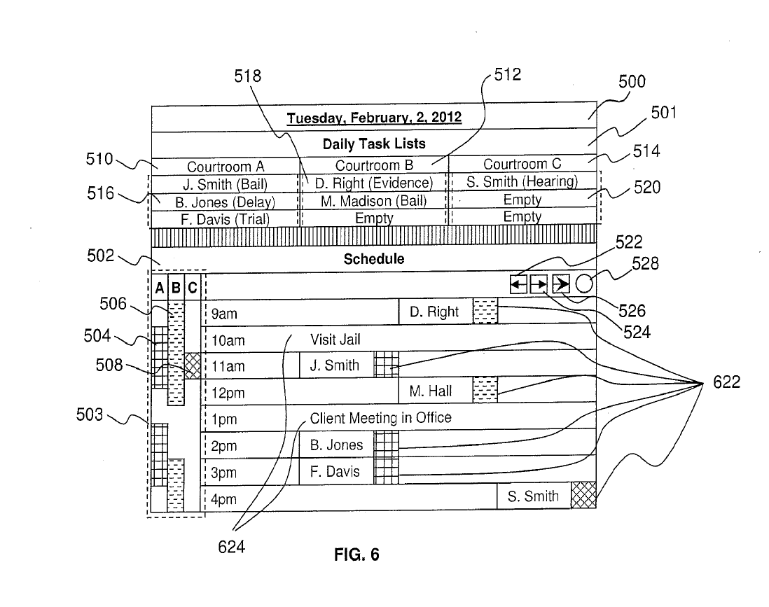

FIG. 6 is an example user interface which is similar to that of FIG. 5 in some respects wherein each of the tasks listed in the daily task list have been scheduled. An indicium or indication 622 may be provided on each of the scheduled appointments to visually represent the attribute to which the appointment is linked. The indication may be a color scheme, pattern, icon or any other feature that enables a user to determine the attribute to which each appointment is linked. The user interface may further include elements that enable a user to reschedule appointments for the day being displayed to other days, weeks, or months. The user interface enables a user to transfer a task or appointment to another user or another organization. The user interface may further enable the task to be rescheduled with additional or different participants or attributes. For example, selecting element 522 instructs the scheduling module 102 to shift all appointments to the preceding day. Selecting element 524 instructs the scheduling module 102 to shift all appointments to the following day. Similarly, element 526 instructs the scheduling module 102 to shift all appointments to the following week. Option element 528 enables a user to select various other options, for example, to shift all appointments linked to a particular attribute to another day. It will be appreciated that the calendar may also include appointments that have not been linked to an attribute such as appointments 624. In some instances elements 522, 524, and 526 may shift only appointments associated with a single attribute to other day or week.

Option element 528 may be enabled to perform other tasks associated with rescheduling appointments. Furthermore appointments and tasks may be modified by clicking on each of the appointments or tasks or dragging appointments and tasks to new time slots. Moreover a particular task may be associated with an attribute by dragging and dropping that task over an icon representing the attribute. For example, if one of the tasks originally intended to be held in Courtroom B 512 has been moved to Courtroom C 514, the user may drag and drop that task to the appropriate task list and the scheduling module 102 will link the task to Courtroom C 514.

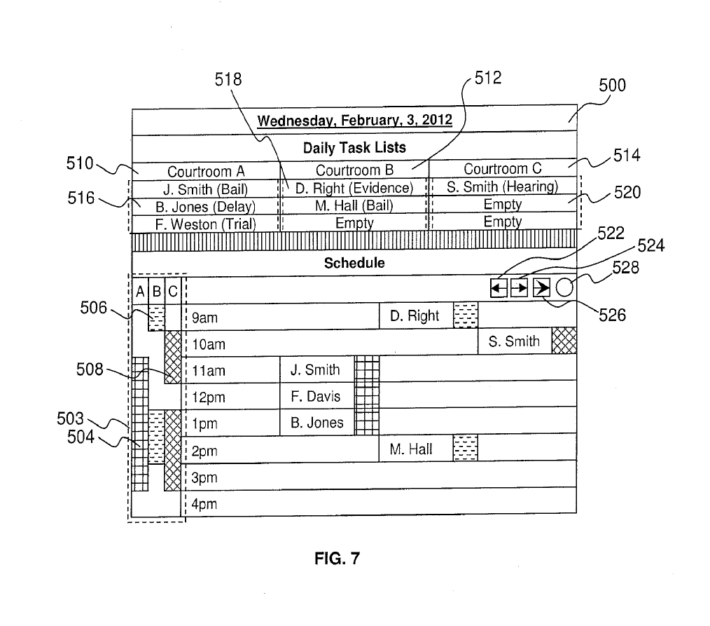

By way of example, a user may wish to move all tasks to a new calendar date. For example, the user of the electronic device may wish to shift all tasks from the current day to the following calendar day. Turning to FIG. 7, an example user interface similar to that of FIG. 6 in some respects represents the following calendar day after all the tasks have been shifted by the scheduling module 102. It may be noted that the tasks not associated with the attributes (such as appointments 624 shown in FIG. 6) may, depending on the user's selection, not be shifted to the following day. The scheduling module 102 may reschedule tasks to be at different time periods of the day depending on the availability of the assets with which the tasks are associated, as was described above. In the schedule of FIG. 7, it can be seen that the tasks were rescheduled to be temporally closer together as well as to minimize travel time between each of the attributes.

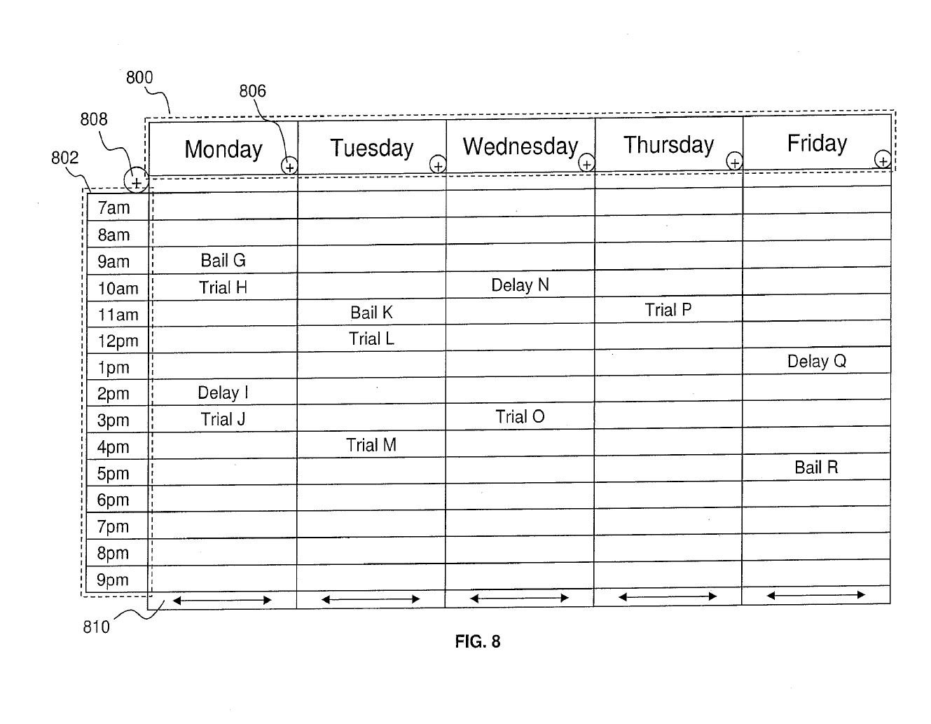

It may be useful for a user to view a schedule corresponding to a lengthier period of time, for example, one week. Turning to FIG. 8, a user interface including a calendar of a work week is provided. The calendar includes headings for each day of the week 800 as well as a listing of potential time slots 802, which may be delineated using any suitable measure of time.

The user interface may be provided with an expansion element 806 to show the selected daily view of scheduled tasks listed by associated attribute. After a user selects the daily expansion element 806, the scheduling module 102 expands the view of the time period in the user interface.

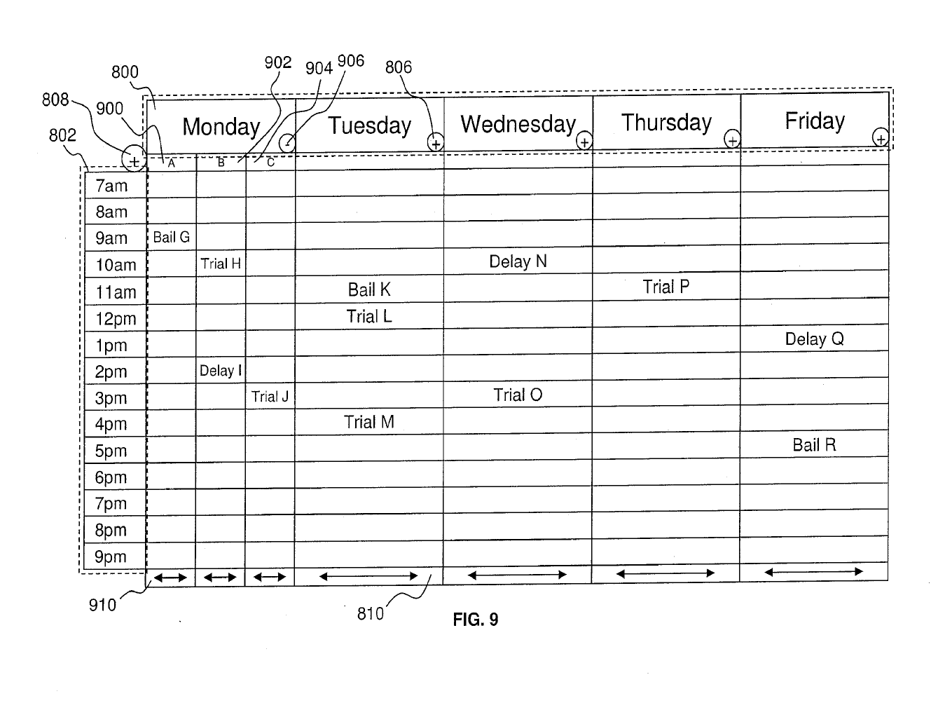

Referring to FIG. 9, an example user interface similar to that of FIG. 8 in some respects is shown with an expanded view of the Monday schedule with each task sorted by attribute. For example, the tasks are listed under courtroom A 900, courtroom B 902, or courtroom C 904. As can be seen from FIG. 9, the time periods may be expanded by selecting the daily expansion element 806. It will be appreciated that any other measure of time may be expanded in a similar manner. Upon expanding one of the time periods, the expansion element 806 may be replaced by a contraction element 906.

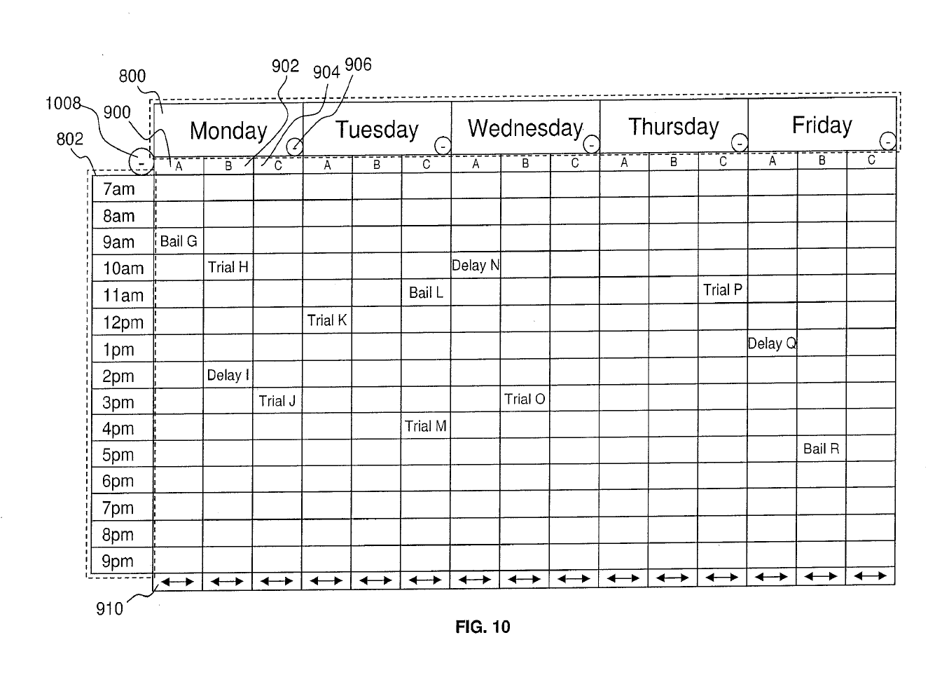

The user interface may further include a weekly expansion element 808 to enable expansion of each of the daily views to show each of the scheduled tasks listed by attribute. By clicking the expansion element 808, each of the time periods may be expanded with a single selection. An example user interface having each of the time periods 800 expanded by attribute is shown in FIG. 10. As can be seen in FIG. 10, upon expanding each of the time periods, the expansion element 808 may be replaced with a contraction element 1008. After a user selects the contraction element 1008, the scheduling module 102 may collapse each of the time periods to show a list of tasks that aren't arranged by attribute.

The user interface may further include time period rescheduling elements 810, as is shown in FIGS. 8 and 9. A user may drag a rescheduling element 810 associated with a first time period and drop the rescheduling element 810 onto the area in the user interface associated with a second time period. After the user drops the rescheduling element 810 onto the area associated with second time period, the scheduling module 102 may reschedule each of the tasks in the first time period to occur in the second time period.

It will be appreciated that the display of tasks based on the attribute with which the tasks are associated enables a user to much more easily view tasks and appointments associated with each task. If the attributes represent a location, for example, a specific address or a room within a large building, a user may more readily visualize whether travel is required between each of the attributes. The user interface may further include an indication of the travel time between two attributes, for example, as an expected travel time. It can be appreciated that, in the example of having appointments scheduled in courtroom A, courtroom B, and courtroom C, it may be much more difficult to visualize whether travel is required between courtrooms and the travel time required between courtrooms if all tasks and appointments are listed in a single column.

Although FIG. 9 shows tasks associated with an attribute and listed by column, the tasks may otherwise, or in addition, be listed in rows, be color-coded, or be visually associated with an attribute in another arrangement. For example, a visualization of an analogue clock may be provided for each attribute, with appointments and tasks related to that attribute distributed at their scheduled times around the circumference of the clock. It will be appreciated that many other visual representations of tasks and appointments associated with one or more attributes fall within the scope of the principles discussed herein.

Similarly, as is best seen in FIG. 10, attribute rescheduling elements 910 may be provided to enable a user to reschedule all tasks associated with a particular attribute over a selected time period. For example, a user may drag an attribute rescheduling element 910 associated with attribute B on Monday to drop the attribute rescheduling element 910 onto the area in the user interface associated with Tuesday. The scheduling module 102 may reschedule the Monday tasks associated with attribute B to Tuesday.

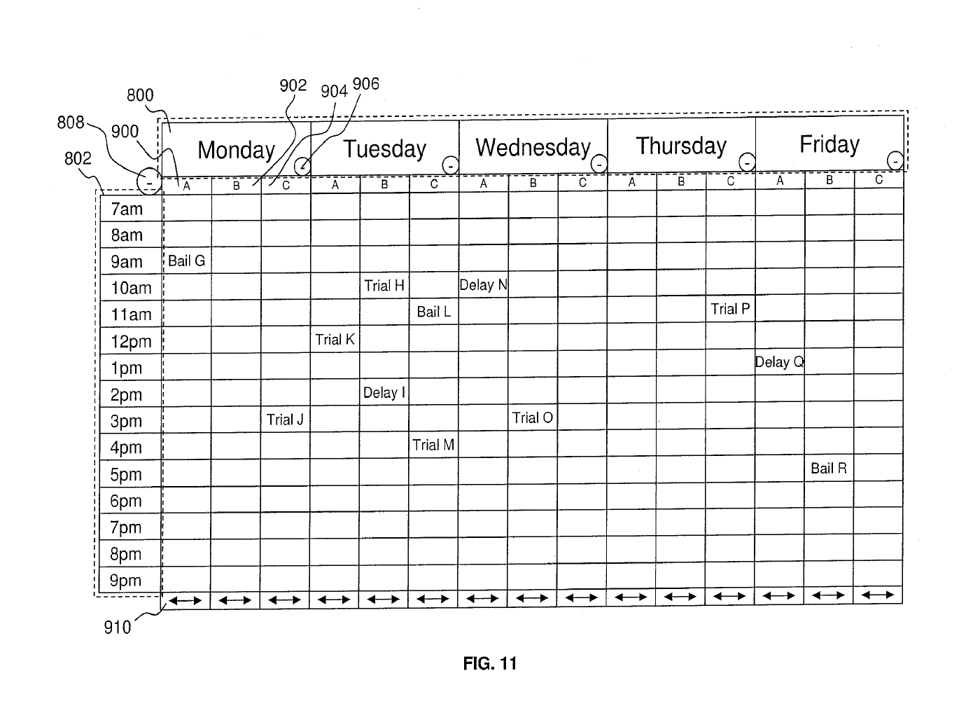

FIG. 11 shows a user interface similar to that of FIG. 10 after Monday tasks associated with attribute B have been rescheduled to Tuesday.

It will be appreciated that although the user interfaces as shown in FIG. 8 to FIG. 11 use drag and drop functionality with the rescheduling elements 810 and attribute rescheduling elements 910 to reschedule tasks, other user interface elements may also be used. For example, the rescheduling elements 810 and the attribute rescheduling elements 910 may include a drop down list, a slider, a single-click button, etc.

Although examples of how the scheduling system, method and user interface may be used for professional services are provided, the scheduling system, method and user interface may be used for scheduling any tasks or appointment and may be used by any person, machine, or entity that may schedule tasks and appointments associated with a plurality of attributes. For example, the user interface may be applicable for scheduling fast food or retail employees, employees in a manufacturing setting, traveling engineers and architects, a corporation's meetings at a conference, patrol routes of police officers, etc. It will be appreciated that the scheduling system, method and user interface may be applied to a wide variety of scheduling requirements.

Accordingly, there is provided a method comprising: retrieving tasks from a memory, each task associated with a non-temporal attribute; and displaying the tasks in a group or list relative to the non-temporal attribute.

There is also provided a computer readable storage medium comprising computer executable instructions for retrieving tasks from a memory, each task associated with a non-temporal attribute; and displaying the tasks in a group or list relative to the non-temporal attribute.

There is also provided an electronic device comprising a processor and memory, the memory comprising computer executable instructions for retrieving tasks from a memory, each task associated with a non-temporal attribute; and displaying the tasks in a group or list relative to the non-temporal attribute.

Referring to FIG. 12, shown therein is a block diagram of an example configuration of another electronic device 19′ in which example embodiments disclosed herein may be implemented. It is configured to communicate over a wireless network 200, e.g., a smart phone, tablet, cell phone, portable gaming device, etc. The electronic device 19′ includes a number of components such as a main processor 302 that controls the overall operation of the electronic device 19′. Communication functions, including data and voice communications, are performed through a communication interface 42. The communication interface 42 receives messages from and sends messages to a wireless network 200. In this example of the electronic device 19′, the communication interface 42 is configured in accordance with the Global System for Mobile Communication (GSM) and General Packet Radio Services (GPRS) standards, which is used worldwide. Other communication configurations that are equally applicable are the 3G and 4G networks such as Enhanced Data-rates for Global Evolution (EDGE), Universal Mobile Telecommunications System (UMTS) and High-Speed Downlink Packet Access (HSDPA), Long Term Evolution (LTE), Worldwide Interoperability for Microwave Access (Wi-Max), etc. New standards are still being defined, but it is believed that they will have similarities to the network behavior described herein, and it will also be understood by persons skilled in the art that the examples described herein are intended to use any other suitable standards that are developed in the future. The wireless link connecting the communication interface 42 with the wireless network 200 represents one or more different Radio Frequency (RF) channels, operating according to defined protocols specified for GSM/GPRS communications.

The main processor 302 also interacts with additional subsystems such as a Random Access Memory (RAM) 306, a flash memory 308, a touch-sensitive display 360, an auxiliary input/output (I/O) subsystem 312, a data port 314, a keyboard 316 (physical, virtual, or both), a speaker 318, a microphone 320, a GPS receiver 321, short-range communications subsystem 322, and other device subsystems 324. Some of the subsystems of the electronic device 19′ perform communication-related functions, whereas other subsystems may provide “resident” or on-device functions. By way of example, the touch-sensitive display 360 and the keyboard 316 may be used for both communication-related functions, such as entering a text message for transmission over the wireless network 200, and device-resident functions such as a calculator or task list. In one example, the electronic device 19′ can include a non touch-sensitive display in place of, or in addition to the touch-sensitive display 360. For example the touch-sensitive display 360 can be replaced by a display 104 that may not have touch-sensitive capabilities.

The electronic device 19′ can send and receive communication signals over the wireless network 200 after required network registration or activation procedures have been completed. Network access is associated with a subscriber or user of the electronic device 19′. To identify a subscriber, the electronic device 19′ may use a subscriber module component or “smart card” 326, such as a Subscriber Identity Module (SIM), a Removable User Identity Module (RUIM) and a Universal Subscriber Identity Module (USIM). In the example shown, a SIM/RUIM/USIM 326 is to be inserted into a SIM/RUIM/USIM interface 328 in order to communicate with a network.

The electronic device 19′ is typically a battery-powered device and includes a battery interface 332 for receiving one or more rechargeable batteries 330. In at least some examples, the battery 330 can be a smart battery with an embedded microprocessor. The battery interface 332 is coupled to a regulator (not shown), which assists the battery 330 in providing power to the electronic device 19′. Although current technology makes use of a battery, future technologies such as micro fuel cells may provide the power to the electronic device 19′.

The electronic device 19′ also includes an operating system 334 and software components 338 to 342, 102, 105, and 106. The operating system 334 and the software components 338 to 342, 102, 105, and 106, that are executed by the main processor 302 are typically stored in a persistent store such as the flash memory 308, which may alternatively be a read-only memory (ROM) or similar storage element (not shown). Those skilled in the art will appreciate that portions of the operating system 334 and the software components 338 to 342, 102, 105, and 106, such as specific device applications, or parts thereof, may be temporarily loaded into a volatile store such as the RAM 306. Other software components can also be included, as is well known to those skilled in the art.

The subset of software applications 336 that control basic device operations, including data and voice communication applications, may be installed on the electronic device 19′ during its manufacture. Software applications may include a message application 338, a device state module 340, a Personal Information Manager (PIM) 342, a scheduling module 102, a calendar application 105. A task database 106 is also shown in FIG. 12, which may be located in a memory or other data storage device. A message application 338 can be any suitable software program that allows a user of the electronic device 19′ to send and receive electronic messages, wherein messages are typically stored in the flash memory 308 of the electronic device 19′. A device state module 340 provides persistence, i.e. the device state module 340 ensures that important device data is stored in persistent memory, such as the flash memory 308, so that the data is not lost when the electronic device 19′ is turned off or loses power. A PIM 342 includes functionality for organizing and managing data items of interest to the user, such as, but not limited to, e-mail, contacts, calendar events, and voice mails, and may interact with the wireless network 200.

Other types of software applications or components 339 can also be installed on the electronic device 19′. These software applications 339 can be pre-installed applications (i.e. other than message application 338) or third party applications, which are added after the manufacture of the electronic device 19′. Examples of third party applications include games, calculators, utilities, etc.

The additional applications 339 can be loaded onto the electronic device 19′ through at least one of the wireless network 200, the auxiliary I/O subsystem 312, the data port 314, the short-range communications subsystem 322, or any other suitable device subsystem 324.

The data port 314 can be any suitable port that enables data communication between the electronic device 19′ and another computing device. The data port 314 can be a serial or a parallel port. In some instances, the data port 314 can be a universal serial bus (USB) port that includes data lines for data transfer and a supply line that can provide a charging current to charge the battery 330 of the electronic device 19′.

For voice communications, received signals are output to the speaker 318, and signals for transmission are generated by the microphone 320. Although voice or audio signal output is accomplished primarily through the speaker 318, the display 360 (or 104) can also be used to provide additional information such as the identity of a calling party, duration of a voice call, or other voice call related information.

The touch-sensitive display 360 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. In the presently described example, the touch-sensitive display 360 is a capacitive touch-sensitive display which includes a capacitive touch-sensitive overlay 364. The overlay 364 may be an assembly of multiple layers in a stack which may include, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

The display 104 of the touch-sensitive display 360 may include a display area in which information may be displayed, and a non-display area extending around the periphery of the display area. Information is not displayed in the non-display area, which is utilized to accommodate, for example, one or more of electronic traces or electrical connections, adhesives or other sealants, and protective coatings, around the edges of the display area.

One or more touches, also known as touch contacts or touch events, may be detected by the touch-sensitive display 360. The processor 302 may determine attributes of the touch, including a location of a touch. Touch location data may include an area of contact or a single point of contact, such as a point at or near a center of the area of contact, known as the centroid. A signal is provided to the controller 366 in response to detection of a touch. A touch may be detected from any suitable object, such as a finger, thumb, appendage, or other items, for example, a stylus, pen, or other pointer, depending on the nature of the touch-sensitive display 360. The location of the touch moves as the detected object moves during a touch. One or both of the controller 366 and the processor 302 may detect a touch by any suitable contact member on the touch-sensitive display 360. Similarly, multiple simultaneous touches, are detected.

One or more gestures are also detected by the touch-sensitive display 360. A gesture is a particular type of touch on a touch-sensitive display 360 that begins at an origin point and continues to an end point. A gesture may be identified by attributes of the gesture, including the origin point, the end point, the distance travelled, the duration, the velocity, and the direction, for example. A gesture may be long or short in distance and long or short in duration. Two points of the gesture may be utilized to determine a direction of the gesture.

An example of a gesture is a swipe (also known as a “flick”). A swipe has a single direction. The touch-sensitive overlay 364 may evaluate swipes with respect to the origin point at which contact is initially made with the touch-sensitive overlay 364 and the end point at which contact with the touch-sensitive overlay 364 ends rather than using each of location or point of contact over the duration of the gesture to resolve a direction.

Examples of swipes include a horizontal swipe, a vertical swipe, and a diagonal swipe. A horizontal swipe typically includes an origin point towards the left or right side of the touch-sensitive overlay 364 to initialize the gesture, a horizontal movement of the detected object from the origin point to an end point towards the right or left side of the touch-sensitive overlay 364 while maintaining continuous contact with the touch-sensitive overlay 364, and a breaking of contact with the touch-sensitive overlay 364. Similarly, a vertical swipe typically includes an origin point towards the top or bottom of the touch-sensitive overlay 364 to initialize the gesture, a horizontal movement of the detected object from the origin point to an end point towards the bottom or top of the touch-sensitive overlay 364 while maintaining continuous contact with the touch-sensitive overlay 364, and a breaking of contact with the touch-sensitive overlay 364.

Swipes can be of various lengths, can be initiated in various places on the touch-sensitive overlay 364, and need not span the full dimension of the touch-sensitive overlay 364. In addition, breaking contact of a swipe can be gradual in that contact with the touch-sensitive overlay 364 is gradually reduced while the swipe is still underway.

Meta-navigation gestures may also be detected by the touch-sensitive overlay 364. A meta-navigation gesture is a gesture that has an origin point that is outside the display area of the touch-sensitive overlay 364 and that moves to a position on the display area of the touch-sensitive display. Other attributes of the gesture may be detected and be utilized to detect the meta-navigation gesture. Meta-navigation gestures may also include multi-touch gestures in which gestures are simultaneous or overlap in time and at least one of the touches has an origin point that is outside the display area and moves to a position on the display area of the touch-sensitive overlay 364. Thus, two fingers may be utilized for meta-navigation gestures. Further, multi-touch meta-navigation gestures may be distinguished from single touch meta-navigation gestures and may provide additional or further functionality.

In some examples, an optional force sensor 370 or force sensors is disposed in any suitable location, for example, between the touch-sensitive display 360 and a back of the electronic device 19′ to detect a force imparted by a touch on the touch-sensitive display 360. The force sensor 370 may be a force-sensitive resistor, strain gauge, piezoelectric or piezoresistive device, pressure sensor, or other suitable device. Force as utilized throughout the specification refers to one or more of force measurements, estimates, and calculations, such as pressure, deformation, stress, strain, force density, force-area relationships, thrust, torque, and other effects that include force or related quantities.

Force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the electronic device 19, server 107, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method comprising:
retrieving tasks from a memory, each task associated with a non-temporal attribute; and
displaying the tasks in a group or list relative to the non-temporal attribute.

2. The method of claim 1 further comprising displaying a time or range of times in which the task may be performed.

3. The method of claim 1 further comprising providing an option to select all tasks associated with a particular attribute.

4. The method of claim 3 further comprising displaying a time available in which the tasks may be rescheduled.

5. The method of claim 4 further comprising presenting an option to reschedule all tasks associated with the particular attribute.

6. The method of claim 5 wherein the particular attribute is a physical location.

7. The method of claim 6 further comprising:
determining which attributes have expected travel times therebetween;
generating an estimate of an expected travel time between at least a pair of attributes; and
providing the expected travel time.

8. The method of claim 7 further comprising:
detecting a real-time change in the expected travel time between the pair of attributes; and
rescheduling or canceling one or more tasks based on a change in the expected travel time.

9. The method of claim 1 further comprising one or more rankings associated with moveability, task importance, or temporal importance of a particular task.

10. The method of claim 9 further comprising rescheduling or canceling a task based on one or more ranking of the particular task.

11. The method of claim 1 further comprising providing a plurality of lists of tasks, each list being associated with a common attribute.

12. The method of claim 1 further comprising providing a plurality of task schedules, each schedule being associated with a common attribute.

13. The method of claim 12 further comprising enabling a task list or task schedule to be collapsed to view tasks regardless of an associated attribute.

14. A computer program product comprising:
a computer readable storage medium with executable instructions for performing a method comprising:
retrieving tasks from a memory, each task associated with a non-temporal attribute; and
displaying the tasks in a group or list relative to the non-temporal attribute.

15. An electronic device comprising:
a processor and memory, the memory comprising computer executable instructions for performing:
retrieving tasks from a memory, each task associated with a non-temporal attribute; and
displaying the tasks in a group or list relative to the non-temporal attribute.

16. The electronic device of claim 15 further comprising displaying a time or range of times in which the task may be performed.

17. The electronic device of claim 15 further comprising providing an option to select all tasks associated with a particular attribute.

18. The electronic device of claim 17 further comprising displaying a time available in which the tasks may be rescheduled.

19. The electronic device of claim 18 further comprising presenting an option to reschedule all tasks associated with the particular attribute.

20. The electronic device of claim 19 wherein the particular attribute is a physical location.
